(19) United States
(12) Patent Application Publication
(10) Pub. No.: US 2014/0368851 A1
(43) Pub. Date: Dec. 18, 2014

(54) IMAGE READING APPARATUS, ERASING APPARATUS AND IMAGE READING METHOD

(71) Applicants: TOSHIBA TEC KABUSHIKI KAISHA, Tokyo (JP); KABUSHIKI KAISHA TOSHIBA, Tokyo (JP)

(72) Inventor: Yuichi Saito, Numazu-shi (JP)

(21) Appl. No.: 14/246,431

(22) Filed: Apr. 7, 2014

(30) Foreign Application Priority Data
Jun. 12, 2013 (JP) 2013-123262

(51) Int. Cl. H04N 1/00; H04N 1/60; H04N 1/12

(52) U.S. Cl. CPC H04N 1/00726; H04N 1/00588; H04N 1/00602; H04N 1/00737; H04N 1/00795; H04N 1/121; H04N 1/6094; H04N 2201/0094; H04N 2201/0081
USPC 358/1.13; 358/498

(57) ABSTRACT

In accordance with one embodiment, an image reading apparatus comprises a conveyance section, a reading section, a flexible unit and a control section. The conveyance section conveys a sheet along a conveyance path. The reading section arranged along the conveyance path reads the surface of the conveyed sheet. The flexible unit flexes the sheet conveyed towards the reading section. The control unit controls the flexible unit to flex the sheet when the reading section carries out a first reading processing of reading an image representing the surface state of the sheet.

### CROSS-REFERENCE TO RELATED APPLICATION

This application is based upon and claims the benefit of priority from the prior Japanese Patent Application No. 2013-123262, filed on Jun. 12, 2013, the entire contents of which are incorporated herein by reference.

### FIELD

Embodiments described herein relate to an image reading apparatus for reading an image formed on a sheet, an erasing apparatus for erasing the image and an image reading method.

### BACKGROUND

Conventionally, in an erasing apparatus for erasing an image on a sheet such as a recording paper to make the sheet reusable an image reading apparatus carries out a reading processing to store the image on the sheet. Further, the image reading apparatus also carries out the reading processing in a case of recognizing the state of the sheet to determine whether or not the sheet is reusable.

However, when carrying out a reading processing to recognize whether a sheet is in a folded, ripped or crumpled state, the image reading apparatus is low in recognition precision.

### BRIEF DESCRIPTION OF THE DRAWINGS

The accompanying drawings, which are incorporated in and constitute a part of this specification, illustrate an embodiment of the invention and together with the description, serve to explain the principles of the invention.

FIG. 1 is a section view illustrating the constitution of an erasing apparatus according to embodiment 1;

FIG. 2 is a section view illustrating the constitution of a reading section according to embodiment 1;

FIG. 3 is a control block diagram illustrating the hardware constitution of an erasing apparatus according to embodiment 1;

FIG. 4 is a flowchart illustrating the control carried out in a fourth color erasing mode according to embodiment 1;

FIG. 5 is a section view illustrating the constitution of a reading section according to embodiment 2;

FIG. 6 is a flowchart illustrating the control carried out in a fourth color erasing mode according to embodiment 2;

FIG. 7 is a section view illustrating the constitution of a reading section according to embodiment 3; and

FIG. 8 is a flowchart illustrating the control carried out in a fourth color erasing mode according to embodiment 3.

### DETAILED DESCRIPTION

Reference will now be made in detail to the present embodiment of the invention, an example of which is illustrated in the accompanying drawing.

In accordance with one embodiment, an image reading apparatus comprises a conveyance section, a reading section, a flexible unit and a control section. The conveyance section conveys a sheet along a conveyance path. The reading section arranged along the conveyance path reads the surface of the conveyed sheet. The flexible unit flexes the sheet conveyed towards the reading section. The control unit controls the flexible unit to flex the sheet when the reading section carries out a first reading processing of reading an image representing the surface state of the sheet.

Embodiments of the present invention are described in detail below with reference to accompanying drawings.

### Embodiment 1

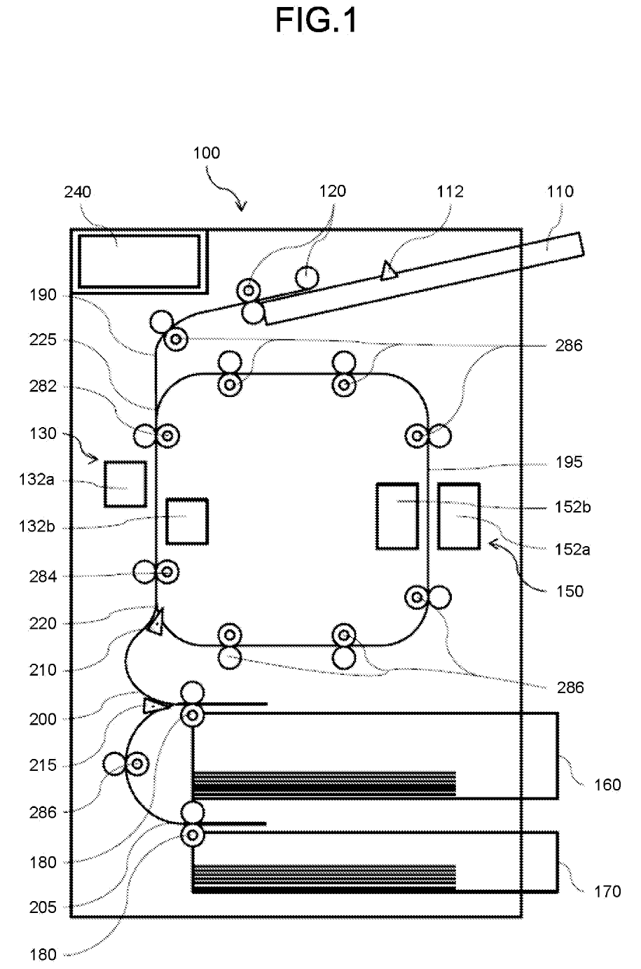

Embodiment 1 is described below with reference to FIG. 1 to FIG. 4. The image reading apparatus provided in the embodiment 1 is used as the reading section of an erasing apparatus.

The erasing apparatus carries out a color erasing processing on a sheet such as a recording paper on which an image is formed with color erasable material such as a color erasable toner or color erasable ink and the like so as to erase the color of the image. The color erasable material contains a color generation compound, a color developing agent and a color erasing agent. The color generation compound is, for example, a leoco dye. The color developing agent is, for example, a phenol. The color erasing agent is, for example, a substance which compatibilizes with the color generation compound under the application of heat (heating to a color erasing temperature, for example), and furthermore, does not have affinity with the color developing agent. The color erasable material generates a color through the interoperation of the color generation compound and the color developing agent. On the other hand, as the interoperation of the color generation compound and the color developing agent is eliminated by the heating above a color erasing temperature, the color of the color erasable material disappears or is erased. The specific color erasing temperature in any embodiment varies depending on the specific color generation compound and a color erasing agent employed. Hereinafter, the color erasable material is briefly referred to as a recording material.

The constitution and the operations of the erasing apparatus provided in the present embodiment are described below.

FIG. 1 is a section view illustrating the constitution of an erasing apparatus 100 provided in embodiment 1. The erasing apparatus 100 comprises a paper feed tray 110, a paper feed component 120, a reading section 130, an erasing section 150, a first tray 160, a second tray 170, a discharging component 180, a first conveyance path 190, a second conveyance path 195, a third conveyance path 200, a fourth conveyance path 205, a first bifurcating component 210, a second bifurcating component 215, a bifurcating point 220, a mergence point 225, an operation section 240 and a plurality of conveyance rollers 286.

The paper feed tray 110 holds reusable sheets. The reusable sheet is, for example, the sheet on which an image was formed by the recording material. Further, the sheet can be of various sizes such as A3, A4 and B5 and the like. The paper feed component 120 is equipped with a pickup roller, a sheet feed roller and a separation roller arranged opposite to the sheet feed roller. The paper feed component 120 conveys, one by one, the sheets on the paper feed tray 110 to the first conveyance path 190 inside the erasing apparatus 100.

The paper feed tray 110 has a detection sensor 112 for detecting whether or not there are sheets on the paper feed tray 110. The detection sensor 112 is, for example, a micro sensor or a micro actuator.

The first conveyance path 190 is a conveyance path formed from the paper feed tray 110 to the bifurcating point 220 where the second conveyance path 195 which will be described later bifurcates from the first conveyance path. The first conveyance path 190 has an inlet roller 282 and an outlet roller 284 The inlet roller 282 is positioned at the upstream side of the reading section 130 which is arranged along the first conveyance path 190 and will be described later in a sheet conveyance direction (hereinafter referred to as an upstream side for short) to convey a fed sheet to the reading section 130. The outlet roller 284 is located at the downstream side of the reading section 130 in the sheet conveyance direction (hereinafter referred to as a downstream side for short) to convey a sheet conveyed from the reading section 130 to the bifurcating point 220. Further, the inlet roller 282 and the outlet roller 284 have a drive roller and a driven roller, respectively.

The reading section 130, which is arranged at the downstream side of the paper feed tray 110 along the first conveyance path 190, has a first reading unit 132a and a second reading unit 132b which are arranged opposite to each other across the first conveyance path 190. The first reading unit 132a and the second reading unit 132b read images on the first surface and the second surface serving as the back side of a conveyed sheet. That is, in the reading section 130, the first reading unit 132a and the second reading unit 132b read the images on two sides of a sheet conveyed in the first conveyance path 190.

The first bifurcating component 210 is arranged at the bifurcating point 220 of the first conveyance path 190 at the downstream side of the reading section 130. The first bifurcating component 210 switches the conveyance direction of a sheet fed from the reading section 130 to the bifurcating point 220. The first bifurcating component 210 selectively distributes a sheet conveyed in the first conveyance path 190 into the second conveyance path 195 or the third conveyance path 200.

The second conveyance path 195, which comprises a plurality of conveyance rollers 286, bifurcates from the first conveyance path 190 at the bifurcating point 220. Further, the second conveyance path 195 is merged with the first conveyance path 190 at the mergence point 225 at the upstream side of the reading section 130. That is, the first conveyance path 190 and the second conveyance path 195 form a circular conveyance path via the bifurcating point 220 and the mergence point 225. The erasing section 150 which will be described later can be arranged on the second conveyance path 195. Therefore, the circular conveyance path can convey a sheet conveyed from the reading section 130 towards the reading section 130 again via the erasing section 150. In other words, by means of controlling the first bifurcating component 210 by the erasing apparatus 100, the conveyance section 280 conveys a sheet fed from the paper feed component 120 from the reading section 130, through the erasing section 150 and then back to the reading section 130 if desired and/or otherwise necessary.

The erasing section 150 comprises, for example, a first erasing unit 152a and a second erasing unit 152b, which, as shown in FIG. 1, are arranged opposite to each other across the second conveyance path 195 to carry out a color erasing processing of erasing colors of the images on two sides of a conveyed sheet. The color erasing processing is described below. The erasing section 150 heats a conveyed sheet to a color erasing temperature in a state of contacting with the conveyed sheet, thereby erasing colors of the images formed on the sheet with a recording material. The first erasing unit 152a of the erasing section 150 is contacted with and heats one side of a sheet. The second erasing unit 152b is contacted with and heats the other side of a sheet. That is, the erasing section 150 erases the images on two sides of a conveyed sheet in one conveyance process.

The operation section 240 having, for example, a touch panel type display section and various operation keys is arranged on the upper portion of the main body of the erasing apparatus 100. The operation keys include, for example, numeric keys, a stop key and a start key and the like. By operating the operation section 240, a user instructs a functional operation of the erasing apparatus 100, such as the start of a color erasing processing or the reading of an image on a sheet to be subjected to a color erasing processing. The operation section 240 displays the setting information, the operation state or the log information of the erasing apparatus 100.

Further, the operation section 240 can also be connected with the operation device of an external apparatus via a network to be operated from the external operation device. Alternatively, the operation 240 can be independent from the main body of the erasing apparatus 100 to operate the erasing apparatus 100 through wired or wireless communication. That is, the operation section 240 described herein can be any operation section that is capable of reading information and giving a processing instruction to the erasing apparatus 100.

The third conveyance path 200 shown in FIG. 1 conveys a sheet passing the bifurcating point 220 to the second bifurcating component 215. As shown in FIG. 1, the conveyed sheet is accommodated, through the second bifurcating component 215, in either of the first tray 160 and the second tray 170 below the former. For example, the second bifurcating component 215 is arranged nearby the under-mentioned discharging component 180 of the first tray 160 to convey the sheet conveyed through the first bifurcating component 210 to the first tray 160 or to the fourth conveyance path 205 which is connected with the third conveyance path 200 via the second bifurcating component 215. The fourth conveyance path 205 comprises a conveyance roller 286 for conveying a sheet to the second tray 170.

If described in detail, the discharging components 180 are respectively arranged on the first tray 160 and the second tray 170 which are arranged above and below at the lower portion of the erasing apparatus 100. The discharging components 180 discharge sheets to the first tray 160 or the second tray 170, respectively. For example, the first tray 160 stores a sheet which is subjected to a color erasing processing and is therefore reusable. The second tray 170 stores a sheet which is determined not to be reusable. The first tray 160 is referred hereinafter to as a reuse tray and the second tray 170 is referred hereinafter to as a reject tray. Further, the sheets to be accommodated in the reuse tray and the reject tray can be switched. The setting of storing what kind of sheets in each tray, that is, the setting on the conveyance destination of the sheets, can be carried out through the operation section 240.

The erasing apparatus 100 comprises a plurality of sheet detection sensors (not shown) for detecting the sheets conveyed in the first to the fourth conveyance paths 190, 195, 200 and 205. The sheet detection sensors, which are, for example, micro sensors or micro actuators, are arranged at proper positions of the conveyance paths.

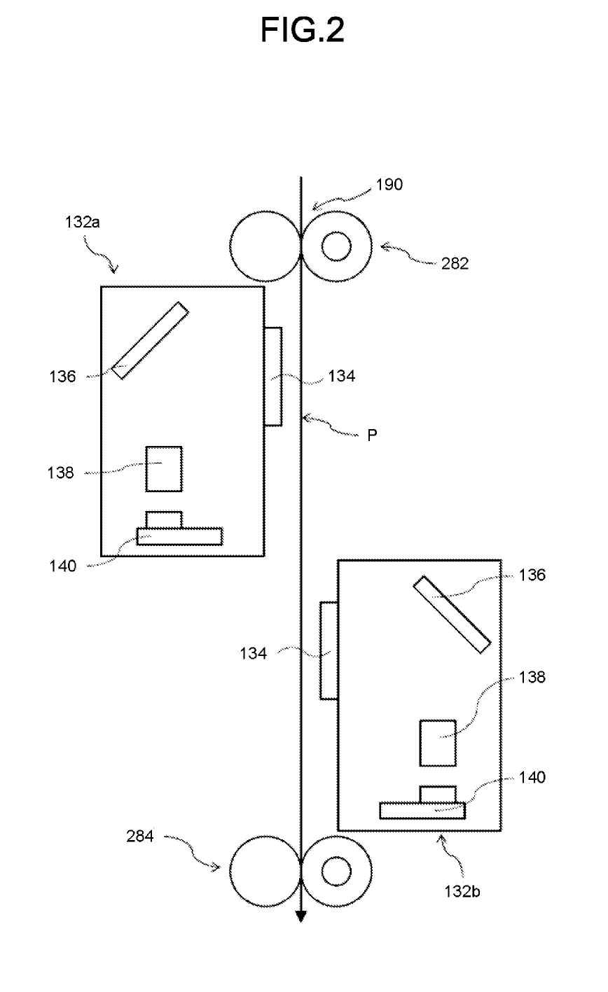

FIG. 2 is a section view illustrating the constitution of the reading section 130 according to embodiment 1. The reading section 130 comprises a first reading unit 132a for reading the first surface of a sheet and a second reading unit 132b for reading the second surface of the sheet. The first reading unit 132a reads an image formed on the surface of a sheet conveyed in the first conveyance path 190. The first reading unit 132a comprises a reading glass 134, a reflecting mirror 136, a lens 138 and a light-receiving element 140. When the first reading unit 132a reads the image formed on a sheet conveyed in the first conveyance path 190, the reflecting mirror 136 reflects the image casting into the first reading unit 132a through the reading glass 134 towards the lens 138. That is, the first reading unit 132a reads the image at a position (reading position) where the sheet is contacted with the reading glass 134. The lens 138 converges the light reflected from the reflecting mirror 136 towards the light-receiving element 140. The light-receiving element 140 can be, for example, a CCD (Charge Coupled Device) scanner or a CMOS (Complementary Metal Oxide Semiconductor) sensor. Further, the second reading unit 132b, which is structurally identical to the first reading unit 132a, is denoted by the same reference sign and is therefore not described herein repeatedly for brevity.

Each section for the control of the erasing apparatus 100 having the aforementioned constitution is described below.

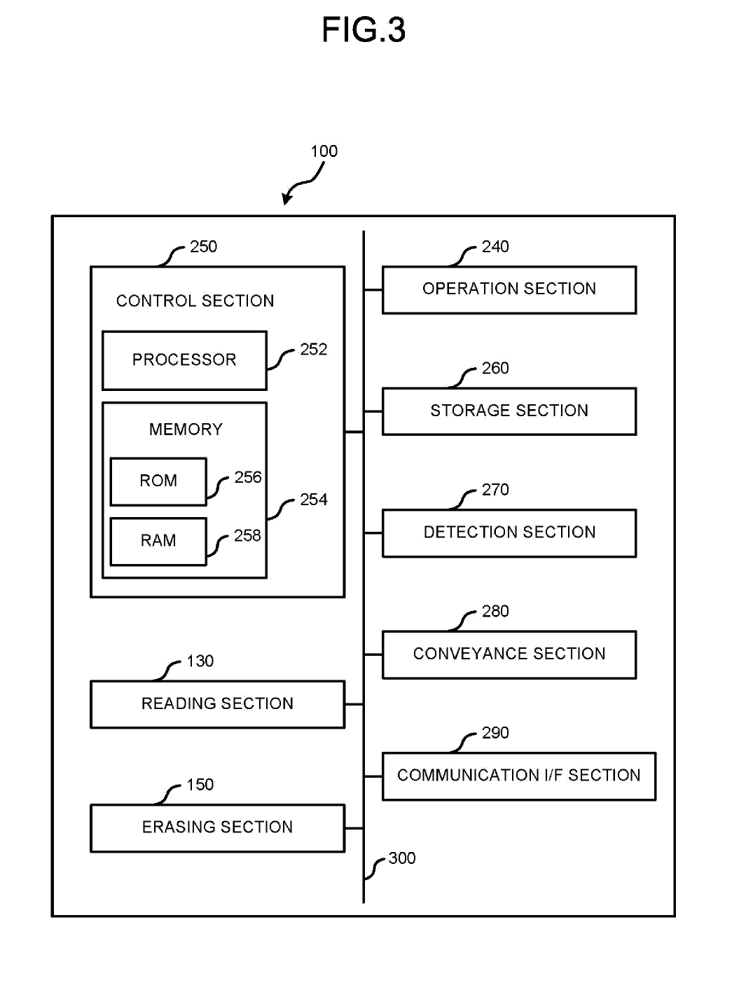

FIG. 3 is a control block diagram illustrating the hardware constitution of the erasing apparatus 100 described in embodiment 1. The erasing apparatus 100 comprises a reading section 130, an erasing section 150, an operation section 240, a control section 250, a storage section 260, a detection section 270, a conveyance section 280 and a communication interface (I/F) section 290, which are all connected with each other via a bus line 300.

The control section 250 has a processor 252 containing a CPU (Central Processing Unit) or a MPU (Micro Processing Unit) and a memory 254. The memory 254, which is, for example, a semiconductor memory, has a ROM (Read Only Memory) 256 for storing various control programs and a RAM (Random Access Memory) 258 for providing a temporary working area for the processor 252. For example, the ROM 256 stores the printing rate of a sheet serving as a threshold value for determining whether or not the sheet is reusable and a concentration threshold value for determining whether or not the image is erased. The RAM 258 can also temporally store the image read by the reading section 130.

The storage section 260 stores the image read by the reading section 130. The storage section 260 can be, for example, a hard disk drive or another magnetic storage device, an optical storage device or a semiconductor storage device such as a flash memory and the like, or any combination thereof. For example, the control section 250 computerizes the image of a sheet read by the reading section 130 and stores in the storage section 260 before the erasing section 150 carries out a color erasing processing so that the data of the erased image can be obtained when needed later.

The detection section 270 has a detection sensor 112 or a paper detection sensor. The control section 250 determines whether or not there is a sheet on the paper feed tray 110 according to a signal from the detection sensor 112.

The conveyance section 280 is provided with a first to a fourth conveyance paths 190, 195, 200 and 205, an inlet roller 282, an outlet roller 284 and a plurality of conveyance rollers 286 which are arranged on the conveyance paths mentioned above, and a plurality of conveyance motors for driving the rollers.

The communication I/F section 290 is an interface connected with an external device. The communication I/F section 290 communicates with an external device on a network through a proper wireless or wired communication based on IEEE802.15, IEEE802.11, IEEE802.3 and IEEE3304 such as Bluetooth (registered trademark), infrared ray connection and optical connection. The communication I/F section 290 can further comprise a USB connection section or a parallel interface connected with a connection terminal of a USB standard. The control section 250 communicates with a multi-functional peripheral or other external devices via the communication I/F section 290. Further, the reading section 130, the erasing section 150 and the operation section 240 which are already described above are not described repeatedly herein.

Each processing executed by the erasing apparatus 100 provided in the present embodiment is described below.

The erasing apparatus 100 can have, for example, the following processing modes. The aforementioned sheet conveyance paths are changed appropriately according to each processing mode executed by the erasing apparatus 100. The under-mentioned sorting processing (a first reading processing) for reference is a processing in which the control section 250 determines whether or not a sheet read by the reading section 130 is reusable based on an image representing the surface state of the sheet and then selectively distributes the sheet to the first tray 160 or the second tray 170 according to the result of the determination. A storage processing (a second reading processing) is a processing of storing the image read by the reading section 130 from a sheet in the storage section 260.

(1) A first color erasing mode in which only a color erasing processing is carried out and the storage processing is not carried out.

(2) A second color erasing mode in which a color erasing processing is carried out after the storage processing.

(3) A third color erasing mode in which the sorting processing is carried out after a color erasing processing and the storage processing is not carried out.

(4) A fourth color erasing mode in which a color erasing processing and the sorting processing are carried out sequentially after the storage processing.

(5) A fifth color erasing mode in which a color erasing processing, if needed, is carried out after the sorting processing, and then the sorting processing is carried out.

(6) A reading mode in which the storage processing is carried out and a color erasing processing is not carried out.

The aforementioned processing modes are selected from the operation section 240 of the erasing apparatus 100. Further, each processing mode can also be set from an external terminal but is not limited to be selected from the operation section 240 of the erasing apparatus 100. A sheet is undoubtedly conveyed to the erasing section 150 in the first to the fifth color erasing mode. On the other hand, in the reading mode, the erasing apparatus 100 controls the first bifurcating component 210 to discharge a sheet from the reading section 130 but not to convey the sheet towards the erasing section 150.

The control section 250 controls the reading section 130, the erasing section 150 and other sections according to the processing modes set by the operation section 240. For example, if the first, second, third, fourth or fifth color erasing mode is selected, the control section 250 enables the erasing section 150 to erase the color of the image on a sheet.

After the color of the image on a sheet is erased by the erasing section 150, when the image on the color-erased sheet is read by the reading section 130 (in the third, fourth or fifth color erasing mode), the control section 250 determines, according to data of the image read by the reading section 130, whether or not the sheet is reusable based on whether or not there is a shadow caused by a fold, a rip or a crumple on the sheet as well as the ratio of the residual image left from the erasing processing. The control section 250 determines which one of the reusable tray and the reject tray is the conveyance destination of the sheet according to the result of the determination. This process can also be referred to as sorting processing.

Further, in the first sorting processing carried out in the fifth color erasing mode, the control section 250 determines, according to the data of the image read by the reading section 130, whether or not the sheet is reusable based on whether or not there is a shadow caused by a fold, rip or crump on the sheet as well as the printing rate of the sheet. The control section 250 determines which one of the erasing section 150 and the reject tray is the conveyance destination of the sheet according to the result of the determination. Further, the storage processing can also be additionally carried out in the sorting processing. That is, the control section 250 determines whether or not the sheet is reusable according to the read image and stores the image in the storage section 260.

On the other hand, when the image on a sheet is read by the reading section 130 before the sheet is conveyed to the erasing section 150 (the second and the fourth color erasing mode), the control section 250 stores the image read by the reading section 130 in the storage section 260 (storage processing). At this time, the control section 250 can also determine whether or not the data of the image on the sheet read by the reading section 130 contains prohibition data which is prohibited to be erased, such as confidential data and the like.

If a reading mode is set in which the image on a sheet is read without carrying out a color erasing processing, the control section 250 controls the first bifurcating component 210 to not convey the sheet to the erasing section 150 after the image on the sheet is read by the reading section 130, and stores the image read by the reading section 130 in the storage section 260.

Next, the conveyance processing of the first conveyance path 190 is described with reference to FIG. 2. The control section 250 changes rotation speeds of the inlet roller 282 and the outlet roller 284 in the sorting processing and the storage processing. In the sorting processing, the control section 250 sets the rotation speed of the inlet roller 282 to be higher than that of the outlet roller 284 (a first setting). That is, the conveyance speed of a sheet is slower and slower towards the downstream side of a conveyance direction, as a result, a flexing force is applied to the sheet from two ends to the center of the conveyance direction. As the shadow caused by a fold, rip or crumple of the sheet is presented apparently by flexing the sheet, the control section 250 can carry out the sorting processing at a high precision.

On the other hand, in the storage processing, the control section 250 sets the rotation speed of the inlet roller 282 to be slower than that of the outlet roller 284 (a second setting). Different in rotation speed, the inlet roller 282 and the outlet roller 284 convey a sheet at different speeds. That is, the conveyance speed of a sheet is faster and faster towards the downstream side, thus, a tension is applied to the sheet in the conveyance direction. With this constitution, the reading section 130 can read a sheet having no crumple. Further, in accompanying drawings, P represents a sheet conveyance path.

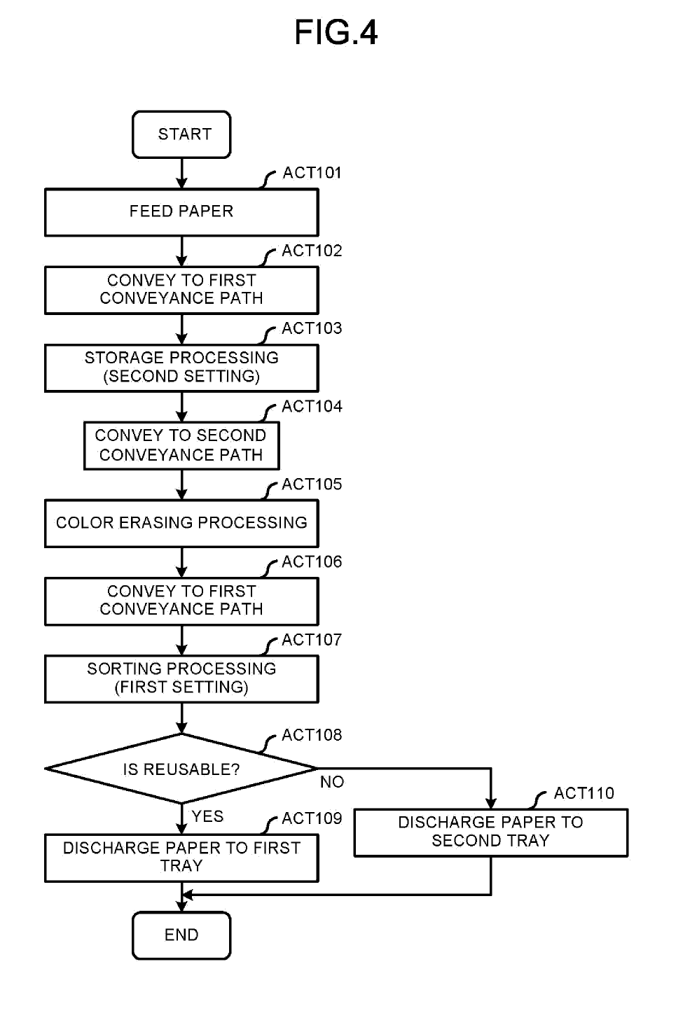

Next, the control flow of the control section 250 is described by taking the fourth color erasing mode as an example. FIG. 4 is a flowchart illustrating the control carried out in the fourth color erasing mode according to embodiment 1. If the fourth color erasing mode is selected by the user, the control section 250 drives the pickup roller of the paper feed component 120 to feed the sheet stacked on the paper feed tray 110 (ACT 101). The control section 250 conveys the fed sheet towards the first conveyance path 190 using the conveyance roller 286 (ACT102). Next, the control section 250 carries out a storage processing of the sheet (ACT103). The control section 250 controls the rotation speeds of the inlet roller 282 and the outlet roller 284 according to the second setting (the rotation speed of the inlet roller 282 is slower than that of the outlet roller 284). In the reading section 130, the first reading unit 132a and the second reading unit 132b read the images on two sides of the sheet and store the read images in the storage section 260. If the storage processing is ended, the control section 250 conveys the sheet subjected to the storage processing towards the second conveyance path 195 (ACT104). The control section 250 drives the first bifurcating component 210 to convey the sheet from the first conveyance path 190 to the second conveyance path 195. The control section 250 carries out color erasing processing on the sheet conveyed to the second conveyance path 195 using the erasing section 150 (ACT105). Then, the control section 250 conveys the color-erased sheet from the second conveyance path 195 to the first conveyance path 190 through the mergence point 225 (ACT106).

The control section 250 carries out the sorting processing on the sheet conveyed to the first conveyance path 190 again (ACT107). The control section 250 controls the rotation speeds of the inlet roller 282 and the outlet roller 284 according to the first setting (the rotation speed of the inlet roller 282 is higher than that of the outlet roller 284). In the reading section 130, the first reading unit 132a and the second reading unit 132b read the images on two sides of the sheet. The control section 250 determines whether or the sheet is reusable according to the read image (ACT108). The control section 250 discharges the sheet to the first tray 160 (ACT109) if the sheet is reusable (YES in ACT108). On the other hand, the control section 250 discharges the sheet to the second tray 170 (ACT110) if the sheet is not reusable (NO in ACT108).

According to the embodiment 1 described above, when the control section carries out the sorting processing, a sheet is conveyed according to the first setting so that the rotation speed of the outlet roller is slower than that of the inlet roller, thereby flexing a sheet to be read. As the shadow caused by a fold, rip or crumple of the sheet is presented apparently by flexing the sheet, the read section can recognize the surface state of the sheet at a high precision.

### Embodiment 2

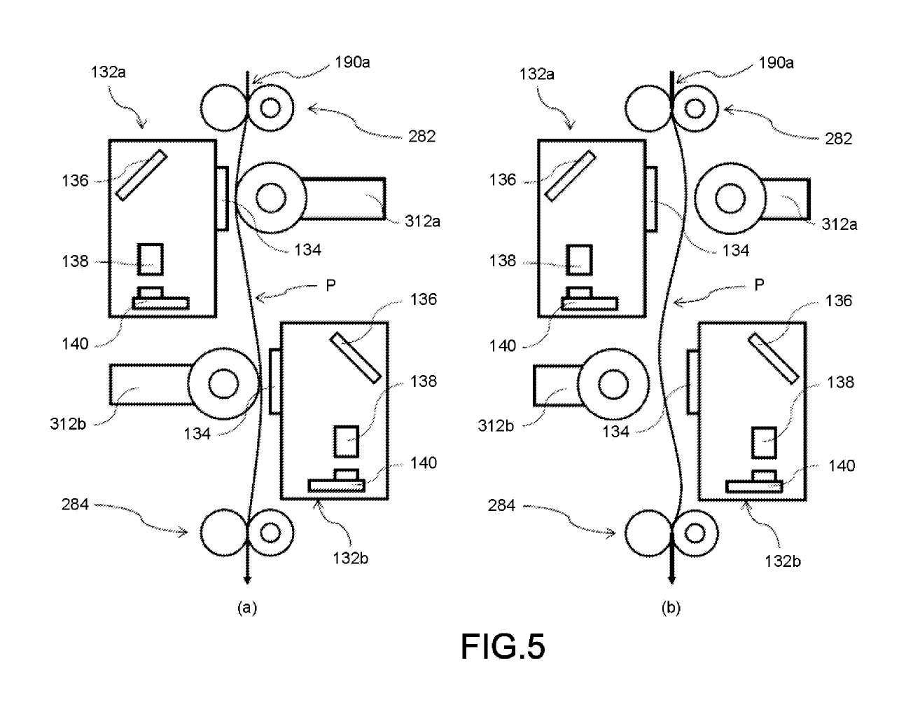

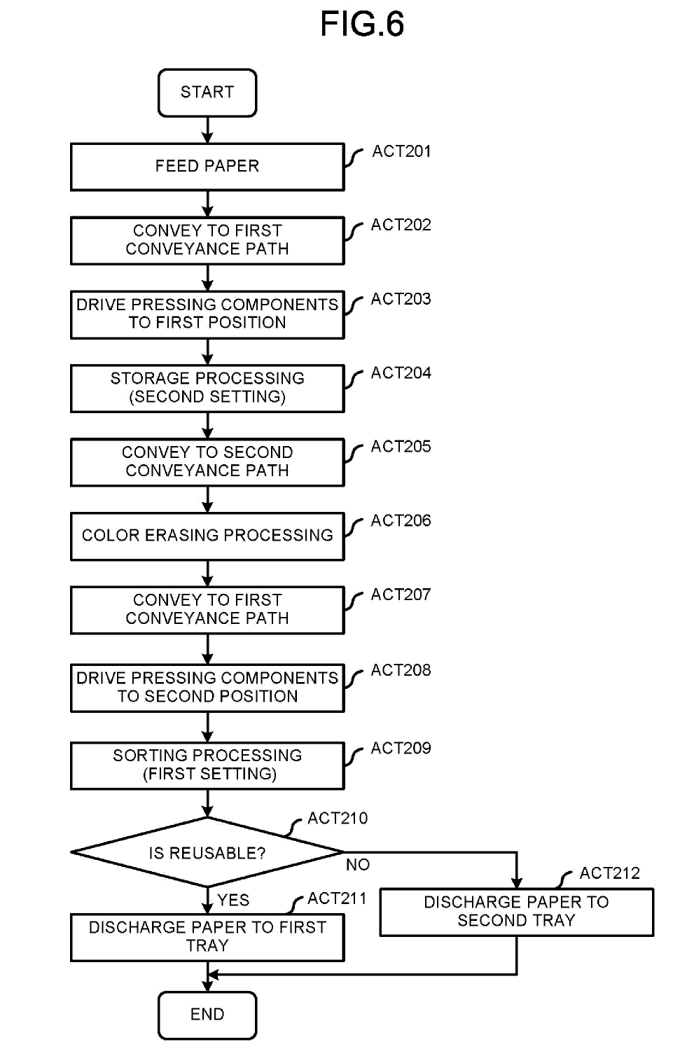

Embodiment 2 is described below with reference to FIG. 5 and FIG. 6.

To control conveyance paths, a movable pressing component is arranged on the first conveyance path of the erasing apparatus described in embodiment 2.

FIG. 5 is a section view illustrating a reading section 130 according to embodiment 2. Compared with the first conveyance path 190 described in embodiment 1, a first conveyance path 190a provided in the present embodiment is wider in the conveyance width between the first reading unit 132a and the second reading unit 132b.

To control sheet conveyance path P, a movable first pressing component 312a is arranged on the first conveyance path 190a at a position opposite to the reading glass 134 of the first reading unit 132a across the first conveyance path 190a. The part of the first pressing component 312a contacted with a sheet is, for example, a driven roller. Under the drive of, for example, a stepping motor, the first pressing component 312a moves towards or away from the reading glass 134 according to an instruction from the control section 250.

Further, to control the sheet conveyance path P, a movable second pressing component 312b is also arranged on the first conveyance path 190a at a position opposite to the reading glass 134 of the second reading unit 132b across the first conveyance path 190a. The second pressing component 312b is structurally identical to the first pressing component 312a and is therefore not described repeatedly here for brevity. Further, the first pressing component 312a and the second pressing component 312b can be collectively referred to as a pressing component.

FIG. 5(a) is a section view illustrating the position of the pressing component when the control section 250 carries out the storage processing. When the control section 250 carries out the storage processing, rotation speeds of the inlet roller 282 and the outlet roller 284 are controlled according to the second setting, and the pressing components are positioned at a first position, which refers to a position where the sheet conveyance path P is guided to diverge from the center part in the conveyance width direction towards the reading units 132a and 132b. In addition to the effect caused by the difference between rotation speeds of the inlet roller 282 and the outlet roller 284, the reading section 130 can read the image on the sheet with a high-quality as the distances between the sheet and the reading units 132a and 132b are forcedly shortened by the pressing component.

FIG. 5(b) is a section view illustrating the position of the pressing component when the control section 250 carries out the sorting processing. When the control section 250 carries out the sorting processing, the rotation speeds of the inlet roller 282 and the outlet roller 284 are controlled according to the first setting, and the pressing components are positioned at a second position, which refers to a position where no inference is caused to a sheet conveyance path P. That is, the second position is a position father away from the reading units 132a and 132b compared with the center part of the conveyance width direction of the first conveyance path 190a. In addition to the effect caused by the difference between the rotation speeds of the inlet roller 282 and the outlet roller 284, the sheet on the first conveyance path 190a is curved as no inference is caused by the pressing components to the sheet conveyance path P, which facilitates the detection on a shadow caused by a fold, rip or crumple of the sheet by the reading section 130 and therefore improves recognition precision.

Next, the control flow of the control section 250 is described by taking the fourth color erasing mode as an example. FIG. 6 is a flowchart illustrating the control carried out in the fourth color erasing mode according to embodiment 2.

In FIG. 6, if a sheet is fed in ACT 201 and then conveyed to the first conveyance path 190a in ACT 202 like in ACT 101 and ACT 102 shown in FIG. 4, in embodiment 2, the control section 250 drives the pressing components to the first position (ACT 203), as shown in FIG. 5(a). The storage processing is carried out in this state (ACT 204). In this state, each pressing component functions to change the conveyance path to close the conveyed sheet to the reading units 132a and 132b. The following ACT 204 to ACT 207 are the same as ACT 103 to ACT 106 shown in FIG. 4 and are therefore not described herein.

Sequentially, if the sheet subjected to a color erasing processing is conveyed to the first conveyance path 190a again in ACT 207 (ACT 106 in FIG. 4), in embodiment 2, the control section 250 drives the pressing components to the second position (ACT 208), as shown in FIG. 5(b). In this state, the processing carried out after the sorting processing is performed, and the processing following ACT 209 shown in FIG. 6 are the same as those following ACT 107 shown in FIG. 4 and are therefore not described herein.

According to embodiment 2 described above, in addition to the effect achieved in embodiment 1, in a case where the control section carries out the sorting processing, as the sheet is curved in the first conveyance path by widening the conveyance width of the first conveyance path, it is easier for the reading section to detect the shadow caused by a fold, rip or crumple of the sheet, therefore, the recognition precision can be improved. Further, when the control section carries out the storage processing, the pressing components close the sheet to corresponding reading units, thereby maintaining reading precision during the storage processing.

### Embodiment 3

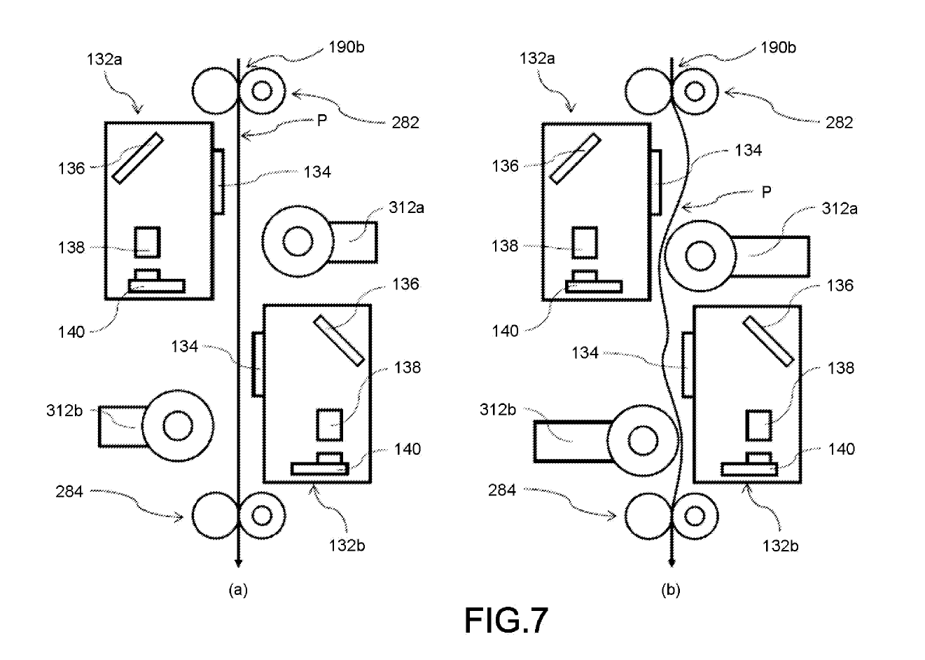

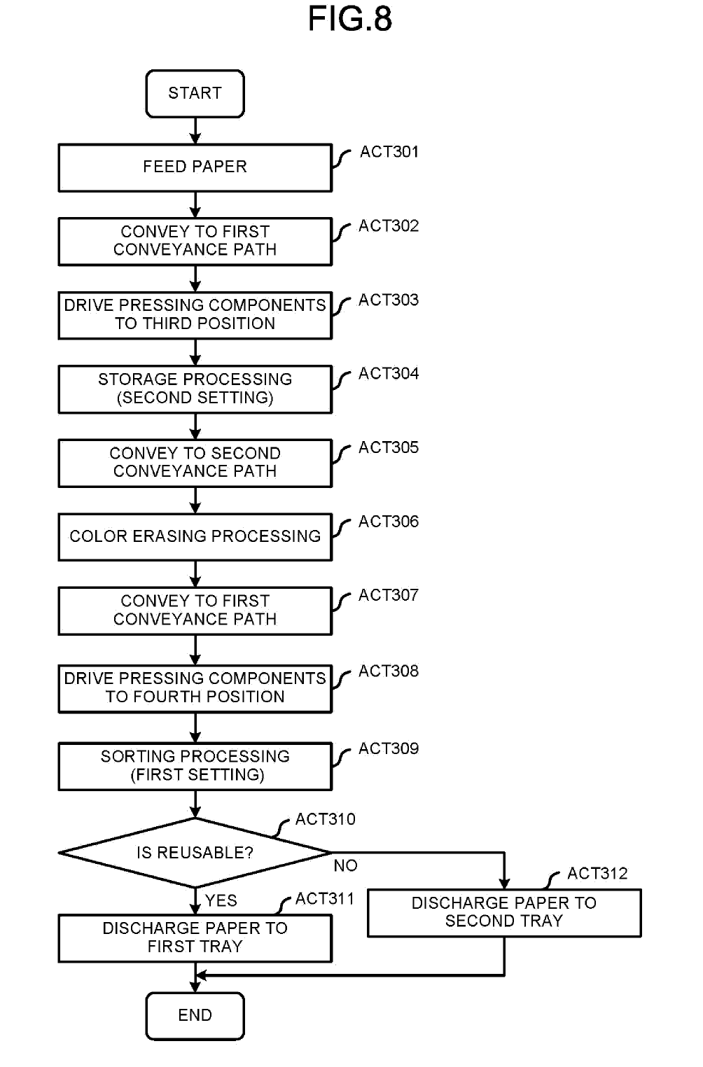

Embodiment 3 is described below with reference to FIG. 7 and FIG. 8.

The first conveyance path described in embodiment 3 is different from that described in embodiment 2 in that the pressing components are not arranged at a position opposite to the reading glass and that sheet conveyance path is changed when the control section carries out the sorting processing.

FIG. 7 is a section view illustrating a first conveyance path 190b according to embodiment 3. In the present embodiment, the first conveyance path 190b is set to have the same conveyance width with that described in embodiment 1. The pressing components described in the present embodiment are structurally identical to those described in embodiment 2, containing a first pressing component 312a and a second pressing component 312b. In the present embodiment, the pressing components are not arranged opposite to the reading glass 134 but arranged at, for example, the downstream side of the reading glass 134.

FIG. 7(a) is a section view illustrating the position of the pressing component when the control section 250 carries out the storage processing. When the control section 250 carries out the storage processing, the rotation speeds of the inlet roller 282 and the outlet roller 284 are controlled according to the second setting, and the pressing components are positioned at a third position, which refers to a position where no inference is caused to a sheet conveyance path P. That is, the third position is a position where the pressing components are farther away from the reading units 132a and 132b compared with the center part of the width direction of the first conveyance path 190b.

FIG. 7(b) is a section view illustrating the position of the pressing component when the control section 250 carries out the sorting processing. When the control section 250 carries out the sorting processing, the rotation speeds of the inlet roller 282 and the outlet roller 284 are controlled according to the first setting, and the pressing components are positioned at a fourth position, which refers to a position where the pressing component makes the sheet conveyance path P closer to the reading units 132a and 132b compared with the center part of the width direction of the sheet conveyance path. As shown in FIG. 7(b), the pressing components curve the sheet conveyance path P to make a shadow caused by a fold, rip or crumple of the sheet apparent, which enables the read section 130 to improve sheet surface recognition precision.

Next, the control flow of the control section 250 is described by taking the fourth color erasing mode as an example. FIG. 8 is a flowchart illustrating the control carried out in a fourth color erasing mode according to embodiment 3.

In FIG. 8, if a sheet is fed in ACT 301 and then conveyed to the first conveyance path 190b in ACT 302 like in ACT 201 and ACT 202 shown in FIG. 6, in embodiment 3, the control section 250 drives the pressing components to the third position (ACT 303), as shown in FIG. 7(a). The storage processing is carried out in this state (ACT 304). In this state, the pressing components are positions where no interference is caused to the sheet conveyance path P. The following ACT 304 to ACT 307 are the same as ACT 204 to ACT 407 shown in FIG. 6 and are therefore not described herein.

Sequentially, if the sheet subjected to a color erasing processing is conveyed to the first conveyance path 190b again in ACT 307 (ACT 207 shown in FIG. 6), in embodiment 3, the control section 250 drives the pressing components to the fourth position (ACT 308), as shown in FIG. 7(b). The fourth position is a position where the pressing components make the sheet conveyance path P closer to the reading units 132a and 132b compared with the center part of the width direction of the sheet conveyance path P. The pressing components change the sheet conveyance path. In this state, the processing carried out after the sorting processing is performed, and the processing following ACT 309 shown in FIG. 8 are the same as those following ACT 209 shown in FIG. 6 and are therefore not described here.

According to the foregoing embodiment 3, in addition to the effect achieved in embodiment 1, the recognition precision of the reading section is improved as the curving of a sheet by the pressing components during the sorting processing executed by the control section facilitates the detection on a shadow caused by a fold, rip or crumple of the sheet.

Further, in a case of executing the sorting processing, the control section may achieve the aforementioned effects by driving the pressing components to the fourth position without controlling rotation speeds of the inlet roller and the outlet roller.

According to any one of the embodiments above, as a sheet is flexed when the control section carries out a sheet sorting processing, it is easier for the reading section to capture the image of a shadow caused by a fold, rip or crumple of the sheet. That is, the reading section can recognize the surface state of the sheet at a high precision.

The present invention is not limited to the foregoing embodiments but can have various variations. For example, it is assumed herein that the image read by the reading section is stored by the storage section of the erasing apparatus; however, the present invention is not limited to this. The control section can also communicate with a user terminal (Personal Computer), a Multi-Functional Peripheral or a server serving as an external device via the communication I/F section to store the image in the storage section of the external device as long as the image data stored in the external device can be read from the operation section of the Multi-Functional Peripheral or the user terminal. Further, in a case where the erasing apparatus has a login and logout function to individually authenticate the user, the image data stored in the RAM or the storage section of the erasing apparatus may be sent to and stored in an external device when logging out of the erasing apparatus.

Further, the control section can also set a concentration threshold value for a shadow which is detected to determine whether or not there is a fold, rip or crumple on the sheet during the sorting processing. That is, if the concentration of the shadow exceeds a given threshold value, it is determined that there is a fold, rip or crumple on the sheet, otherwise, it is determined that there is no fold, rip or crumple on the sheet even though a small crumple exists so long as the sheet can successfully subjected to additional processing. The threshold value can be changed by the user for the user to reuse a sheet meeting a desired quality level.

Further, the ‘color erasing processing’ as used herein referring to the erasing of the color of an image in description of the foregoing embodiments above further includes the erasing of an image. That is, the color erasing apparatus described herein is not limited to an apparatus for erasing the color of an image by heating. For example, the color erasing apparatus may be an apparatus for erasing the color of the image on a sheet through light irradiation or an apparatus for removing (erasing) the image formed on a special sheet. In order to make the sheet reusable, the erasing apparatus can be of any constitution that can make the image formed on a sheet invisible.

While certain embodiments have been described, these embodiments have been presented by way of example only, and are not intended to limit the scope of the present invention. Indeed, the novel embodiments described herein may be embodied in a variety of other forms; furthermore, various omissions, substitutions and changes in the form of the embodiments described herein may be made without departing from the spirit of the present invention. The accompanying claims and their equivalents are intended to cover such forms or modifications as would fall within the scope and spirit of the present invention.

As stated above, the image forming apparatus disclosed herein can optionally or automatically switch between a printing operation with a color-erasable recording material and a printing operation with a color-inerasable recording material, additionally, when the color-erasable recording material is used up and out of stock, the image forming apparatus described herein can continue the printing operation by switching to print with the color-inerasable recording material if the color-erasable recording material cannot be supplemented timely to continue the printing job.

What is claimed is:

1. An image reading apparatus, comprising:
a conveyance section configured to convey a sheet along a conveyance path;
a reading section provided along the conveyance path and configured to read a surface state of the conveyed sheet;
a flexible unit configured to flex the sheet conveyed to the reading section; and
a control section configured to control the flexible unit to flex the sheet when the reading section carries out a first reading processing of reading an image representing the surface state of the sheet.

2. The image reading apparatus according to claim 1, wherein
the flexible unit includes an inlet roller arranged at the upstream side of the reading section along the conveyance path and an outlet roller arranged at the downstream side of the reading section along the conveyance path; and
the control section sets the rotation speed of the inlet roller to be higher than that of the outlet roller when the reading section carries out the first reading processing.

3. The image reading apparatus according to claim 2, wherein
the flexible unit includes a pressing component arranged at a position opposite to a reading position of the reading section and configured for moving between a first position contacted with a sheet conveyed to the reading section and a second position where no interference is caused to the conveyance of the sheet.

4. The image reading apparatus according to claim 2, wherein
the flexible unit includes a pressing component arranged at a position not opposite to the reading position of the reading section and configured for moving between a third position where no interference is caused to the conveyance of a sheet to the reading section and a fourth position contacted with the sheet.

5. The image reading apparatus according to claim 4, wherein
the control section controls the pressing component to move to the fourth position when the reading section carries out the first reading processing.

6. The image reading apparatus according to claim 1, wherein
the flexible unit includes a pressing component contacted with or separated from a sheet conveyed to the reading section according to the reading processing carried out by the reading section.

7. The image reading apparatus according to claim 6, wherein
the pressing component is arranged at a position opposite to the reading position of the reading section and configured for moving between a first position contacted with the sheet conveyed to the reading section and a second position where no interference is caused to the conveyance of the sheet; and
the control section controls the pressing component to move to the second position when the reading section carries out the first reading processing.

8. The image reading apparatus according to claim 6, wherein
the pressing component is arranged at a position not opposite to the reading position of the reading section and configured for moving between a third position where no interference is caused to the conveyance of a sheet towards the reading section and a fourth position contacted with the sheet; and
the control section controls the pressing component to move to the fourth position when the reading section carries out the first reading processing.

9. An erasing apparatus, comprising:
a conveyance section configured to convey a sheet along a conveyance path;
a reading section provided along the conveyance path and configured to read a surface state of the conveyed sheet;
a flexible unit configured to flex the sheet conveyed towards the reading section;
an erasing section provided along the conveyance path and configured to erase an image on the conveyed sheet; and
a control section configured to control the flexible unit to flex the sheet when the reading section carries out a first reading processing of reading an image representing the surface state of the sheet.

10. The erasing apparatus according to claim 9, wherein
the flexible unit includes an inlet roller arranged at the upstream side of the reading section along the conveyance path and an outlet roller arranged at the downstream side of the reading section along the conveyance path; and
the control section sets the rotation speed of the inlet roller to be higher than that of the outlet roller when the reading section carries out the first reading processing.

11. The erasing apparatus according to claim 10, wherein
the flexible unit includes a pressing component arranged at a position not opposite to the reading position of the reading section and configured for moving between a third position where no interference is caused to the conveyance of a sheet towards the reading section and a fourth position contacted with the sheet.

12. The erasing apparatus according to claim 11, wherein
the control section controls the pressing component to move to the fourth position when the reading section carries out the first reading processing.

13. The erasing apparatus according to claim 9, wherein
the flexible unit includes a pressing component contacted with or separated from a sheet conveyed to the reading section according to the reading processing carried out by the reading section.

14. The erasing apparatus according to claim 13, wherein
the pressing component is arranged at a position not opposite to the reading position of the reading section and configured for moving between a third position where no interference is caused to the conveyance of a sheet to the reading section and a fourth position contacted with the sheet; and
the control section controls the pressing component to move to the fourth position when the reading section carries out the first reading processing.

15. An image reading method, including:
conveying a sheet along a conveyance path; and
carrying out, using a reading section, a first reading processing of reading an image representing the state of a sheet conveyed to the reading section in a state where the sheet is flexed by a flexible unit.

16. The image reading method according to claim 15, wherein
the first reading processing is carried out on the sheet conveyed to the reading section in a state where the rotation speed of an inlet roller arranged at the upstream side of the reading section along the conveyance path is set to be higher than that of an outlet roller arranged at the downstream side of the reading section along the conveyance path.

17. The image reading method according to claim 16, wherein
the reading processing of the reading section is carried out in a state where a pressing component is moved between a third position where no interference is caused to the conveyance of a sheet to the reading section and a fourth position contacted with the sheet to be controlled at a specific position.

18. The image reading method according to claim 17, wherein
the first reading processing is carried out in a state where the pressing component is controlled to move to the fourth position.

19. The image reading method according to claim 15, wherein
the reading processing of the reading section is carried out in a state where the pressing component is contacted with or separated from a sheet conveyed to the reading section.

20. The image reading method according to claim 19, wherein
the pressing component arranged at a position not opposite to the reading position of the reading section is moved between the third position where no interference is caused to the conveyance of a sheet to the reading section and the fourth position contacted with the sheet; and
the first reading processing of the reading section is carried out in a state where the pressing component is controlled to move to the fourth position.
